(19) United States
(12) Patent Application Publication
(10) Pub. No.: US 2002/0186699 A1
(43) Pub. Date: Dec. 12, 2002

(54) System and method for providing high-speed communications access over an electrical network

(76) Inventor: Timothy Chung Hing Kwok, Central (HK)

Correspondence Address: Mitchell P. Brook, Baker & McKenzie, 101 Broadway, Twelfth Floor, San Diego, CA, 92101, US

(21) Appl. No.: 09/894,020

(22) Filed: Jun. 27, 2001

Related U.S. Application Data
(60) Provisional application No. 60/296,894, filed on Jun. 8, 2001.

(51) Int. Cl. H04L 12/28

(52) U.S. Cl. 370/401

(57) ABSTRACT

A system and method for providing communications network access over an electrical network of a building are provided. A host unit disposed inside the building is coupled to the communications network via a connection device. The host unit is also coupled to the electrical network of the building via a power distribution point of the building. A subscriber unit disposed inside the building is also coupled to the electrical network and is in communications with the host unit via the electrical network of the building. Signals provided by the communications network reach the subscriber unit via, for example, the public telecommunications network equipment, the connection device, the host unit and the electrical network of the building.

priority is claimed from U.S. Provisional patent Application Serial No. 60/296,894, filed on Jun. 8, 2001, entitled “Hybrid Cabling Configuration for a High Speed Communication System in Multi-Level Buildings”, which is incorporated herein by reference in its entirety.

### FIELD OF THE INVENTION

The present invention generally relates to a system and method for providing high-speed communications access over an electrical network.

### BACKGROUND OF THE INVENTION

Conventional implementations of high-speed access (e.g., broadband access) via copper, cable or wireless networks in, for example, multi-level buildings may suffer from a number of difficulties in the deployment stage. For example, to install a local cable network throughout a multi-level building and, in particular, to reach each apartment, cables may be physically deployed throughout the building and holes would have to be drilled in some walls in each apartment so that each apartment could access the local cable network. In addition, existing constraints such as, for example, limited conduit space and clogged horizontal conduits may provide additional challenges.

In addition, conventional implementations may suffer from the effects of signal fading. Wires such as copper medium, ribbon cable, twisted pair (TP) cables and the like undergo substantial attenuation at higher frequencies that may be used for high-speed communications. Thus, some subscribers in the multi-level building may fall within the boundary of such signal-fading areas and experience interruptions in service or experience transmission rates that are much lower than normal. Additional communications equipment to enhance signals from the signal-fading areas may be costly and labor intensive.

Thus, there is a need for a method and a system that enables fast and easy delivery of high-speed services to end users without experiencing substantial signal fading.

### SUMMARY OF THE INVENTION

The present invention alleviates to a great extent the disadvantages of conventional apparatus and methods for providing communications access.

In an exemplary embodiment, a multi-level building includes power distribution facilities coupled to building units via an electrical network. The building unit may include a subscriber unit that is coupled to the electrical network. The power distribution facility may include a host unit that is also coupled to the electrical network. The subscriber units and the host units, which may be distributed over different floors of the multi-level building, are in communications via the electrical network. Each host unit is also coupled to a connection device which, in turn, is coupled to the communications network. The subscriber units may access the communications network via the electrical network, the host units and the connection device.

Advantageously, the present invention provides a plurality of host units that increase the capacity and transmission rates over the electrical network. Each additional host unit provides an additional resource through which signal traffic may be routed.

In addition, additional host units also provide enhanced coverage throughout the building by extending the reach of power line communications equipment. For example, the effects of signal-fading areas can be reduced since the signal-fading area of one host unit may be covered by another host unit. By using a different host unit, a particular subscriber unit may receive or transmit signals with fewer errors, thereby increasing transmission rates and capacity over the electrical network.

Furthermore, the present invention provides substantial enhancements in bandwidth, data throughput and transmission capacity for the power line communications system deployed within the building. For example, the present invention provides connections between the communications network and the host units via high-speed wiring components such as, for example, category 5 (CAT5) cables, CAT3 cables, fiber cables, an ethernet hub, switch or router.

The present invention also offers a cost effective scheme to deploy high-speed communications services since wiring efforts are substantially reduced resulting in significant savings in terms of costs, labor, time and cable management.

These and other features and advantages of the present invention will be appreciated from review of the following detailed description of the present invention, along with the accompanying figures in which like reference numerals refer to like parts throughout.

### BRIEF DESCRIPTION OF THE DRAWINGS

FIG. 1 shows a schematic representation of high-speed communications access over an electrical network according to the present invention;

FIG. 2 is a schematic representation of high-speed communications access over an electrical network according to the present invention;

FIG. 3A shows a schematic representation of a host unit coupled to an electrical network according to the present invention; and

FIG. 3B shows a schematic representation of a host unit coupled to an electrical network according to the present invention.

### DETAILED DESCRIPTION OF THE INVENTION

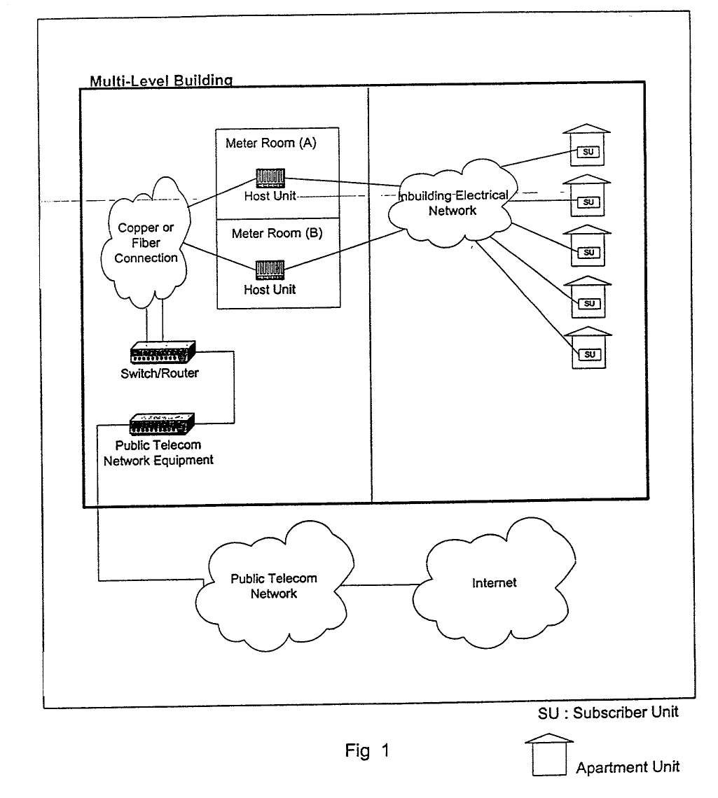

FIG. 1 shows a schematic representation of high-speed communications access over an electrical network according to the present invention. A building 110 is illustrated as including a plurality of building units 120 that each are coupled to an electrical network 130. The building 110 may be, for example, a multi-level or multi-floor building. The building units 120 may be, for example, rooms, offices or apartments. The building units 120 may be spread across multiple floors 140 and the floors 140 need not be adjacent. Each floor 140 may include, for example, one or more building units 120 and a meter room 150. A particular meter room 150 may have a host unit 160 installed therein. A particular building unit 120 may have a subscriber unit 170 installed therein. The host units 160 and the subscriber units 170 are each coupled to the electrical network 130 of the building 110.

Each of the host units 160 are coupled to a connection device 180 via a connector 190 such as, for example, a copper or fiber connection. The connection device 180 may be, for example, a hub, switch or router. The connection device 180 is coupled to public telecommunications network equipment 200 which may be within the building 110. The public telecommunications network equipment 200 is coupled to the public telecommunications network 210 which, in turn, may be coupled, for example, to the internet 220. In another example, the connection device 180 may be coupled to the internet 220 via an internet service provider. Internet is used here as a general term and may include, for example, the internet or any other network known to one of ordinary skill in the art.

The host units 160 and the subscriber units 170 are in communications with each other via the electrical network 130 of the building 110. In addition, the host units 160 are coupled to the public telecommunications network 210 and to the internet 220 via the connection device 180. Accordingly, the subscriber units 120 can be in communications with the internet 220 via the host units 160.

A plurality of host units 160 enhance capacity and transmission rates over the electrical network 130. For example, data transmission rates improve approximately proportional to the number of host units 160 that are used. Additional host units 160 provide enhanced coverage across the electrical network 130. This is especially true for subscriber units 170 that may be in regions (e.g., signal-fade areas) of the building 110 that may experience substantial signal attenuation. The subscriber unit 170 that, for example, sends signals originating from a signal-fade area may have to retransmit the information because the attenuation caused substantial errors in the transmitted signal. Such retransmission may substantially decrease transmission rates and capacity over the electrical network 130. However, with a plurality of host units 160 available, a signal-fade area of one host unit 160 may not be a signal-fade area of another host unit 160. Accordingly, the effects of signal-fade areas in the network can be substantially reduced by selecting the host units 160 that effectively cover the signal-fade areas. In addition, by balancing the traffic through each of the host units 160, capacity and transmission rates may be further enhanced.

Depending on the particular application, the host unit 160 or the subscriber unit 170 may be structured in a number of configurations. The host unit 160 or the subscriber unit 170 may include standard interfaces such as, for example, a single-phase-plus-neutral electrical interface or a three-phase-plus-neutral electrical interface. The host unit 160 or the subscriber unit 170 may also include other standard interfaces such as, for example, a multimode fiber/cable interface, a universal serial bus (USB) interface, a IEEE 802.3 or ISO 8802-3 ethernet interface (e.g., 10BaseT, 100BaseT, 10BaseFL or 100BaseFX ethernet interface) or other interfaces known to those of ordinary skill in the art. The host unit 160 or the subscriber unit 170 may be configured to support communications, networking or internet protocols such as, for example, dynamic host configuration protocol (DHCP), simple network management protocol (SNMP), terminal emulation protocol (telnet), transmission control protocol/internet protocol (TCP/IP) or any other protocols known to those of ordinary skill in the art.

The host unit 160 or the subscriber unit 170 may include, for example, a radio frequency transmitter, a radio frequency receiver, a local oscillator, a radio frequency modulator, a radio frequency demodulator or other communications components known to those of ordinary skill in the art. Thus, for example, the host unit 160 or the subscriber unit 170 may be adapted to modulate or to demodulate signals transmitted or received on carrier frequencies, for example, between approximately 1 MHz and approximately 30 MHz. Furthermore, the host unit 160 or the subscriber unit 170 may be structured to couple and to decouple modulated and demodulated signals to and from its standard interface.

The host unit 160 or the subscriber unit 170 may include onboard memory storage devices that store embedded applications and sub-unit addresses that facilitate connection establishment. The host unit 160 or the subscriber unit 170 may also include processors that store and execute embedded applications and systems. Such applications and systems may provide a variety of functions and capabilities such as, for example, data transmission; data buffering; binary operations; synchronizing; handshaking; dynamic bandwidth allocation and control; encrypting; securing access to the operating environment; or analyzing or reporting, for example, frequency response, signal-to-noise ratios or error rates. The embedded systems (e.g., communications components) and applications may provide connection and control via the logical link control (LLC) and the media access control (MAC) according to IEEE standards such as, for example, IEEE 802.2 LLC, IEEE 802.3 MAC, IEEE 802.1 q VLAN or any other applicable IEEE standards known to one of ordinary skill in the art.

For example, the host unit 160 may be a digital modulation device with a three-phase-plus-neutral electrical interface for connection to a low voltage, AC power line distribution network at one end; and, at another end, an ethernet interface for connection to a telecommunications network. The host unit 160 may also include, for example, a single-phase-plus-neutral electrical interface. The three-phase interface can be converted to a single-phase interface and vice versa by using techniques known to those of ordinary skill in the art.

One or more subscriber units 170 of a particular building unit 120 (e.g., a customer's premises) may be coupled to the telecommunications network over a low-voltage, AC power line distribution network via the host unit 160. The subscriber unit 170 may be, for example, a digital modulation device with a single-phase or three-phase electrical interface for connection to the low voltage, AC power line distribution network on the one end; and, at the other end, an ethernet or Universal Serial Bus (USB) interface for connecting, for example, a computer to the host unit 160 and, ultimately, to the internet 220.

One or more host units 160 may be connected through an ethernet or other types of connectors (e.g., copper or fiber connections) to the connection device 180 such as, for example, a hub, a switch or a router (e.g., an ethernet switch, a digital subscriber line (DSL) router, an ethernet hub). The ethernet may support, for example, 10BaseT, 100BaseT, 10BaseFL or 100BaseFX and may be in compliance with applicable networking standards (e.g., IEEE 802.3 or ISO 8802-3) as are known to those of ordinary skill in the art. The public telecommunications network equipment 200 may include, for example, an asymmetric digital subscriber line (ADSL) modem or an ethernet switch.

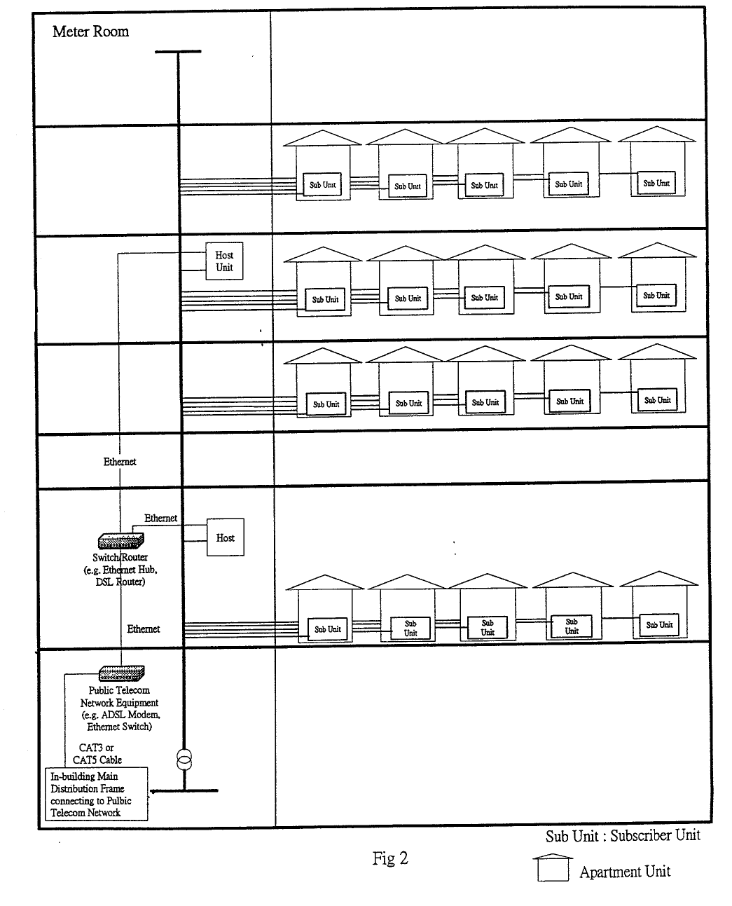

FIG. 2 is a schematic representation of high-speed communications access over an electrical network according to the present invention. In this example, a multi-level building 110 (e.g., an apartment complex) includes multiple floors 140 and the electrical network 130 that extends to each building unit 120. On each floor are a plurality of building units 120. Each of the building units 120 may include a subscriber unit 170. The subscriber units 170 are each coupled to the electrical network 130 via, for example, a power socket. Each floor may include, for example, a meter room 150. Each meter room 150 may include a host unit 160. The host units 160 are each coupled to the electrical network 130. Each host unit 160 is coupled to the connection device 180 via, for example, an ethernet connection. The connection device 180 is coupled to the public telecommunications network equipment 200 via, for example, an ethernet connection. The public telecommunications network equipment 200 is coupled to the public telecommunications network 210 via, for example, a high-speed connection.

The host units 160 may be coupled to the connection device 180 using, for example, category 5 (CAT5) twisted pair cables, CAT3 twisted pair cables, single-mode optical fiber cables, multimode optical fiber cables or other high-speed cable options known to those of ordinary skill in the art to extend the distance coverage of power line transmission in, for example, multi-level buildings 110. The connection device 180 may be coupled to the public telecommunications network 210 or to the internet 220 using many of the same cable options as well as other communications means such as, for example, wireless communications options (e.g., infrared communications, radio-frequency communications, microwave communications, other forms of electromagnetic radiation communications or any other forms of wireless communications known to those of ordinary skill in the art). The use of, for example, high-speed cables increases the overall bandwidth of the power line transmission system. Furthermore, since each host unit 160 is connected directly to, for example, the ethernet router, each host unit 160 may provide optimal capacity to the subscriber units 170. In addition, the cable wiring scheme is easy to deploy and manage.

As described above, the host units 160 are in communications with the subscriber units 170 in the building 110 via the electrical network 130 of the building 110. For example, the subscriber units 170 may be plugged into the power sockets in the building units 120 while the host units 160 are wired into the in-building electrical network 130 through, for example, a fuse box and a circuit breaker located inside a meter room 150. Since the host units 160 are also in communications with the public telecommunications network 210, information from the public telecommunications network 210 flows to the host units 160 before being distributed to the subscriber units 170 inside the building 110.

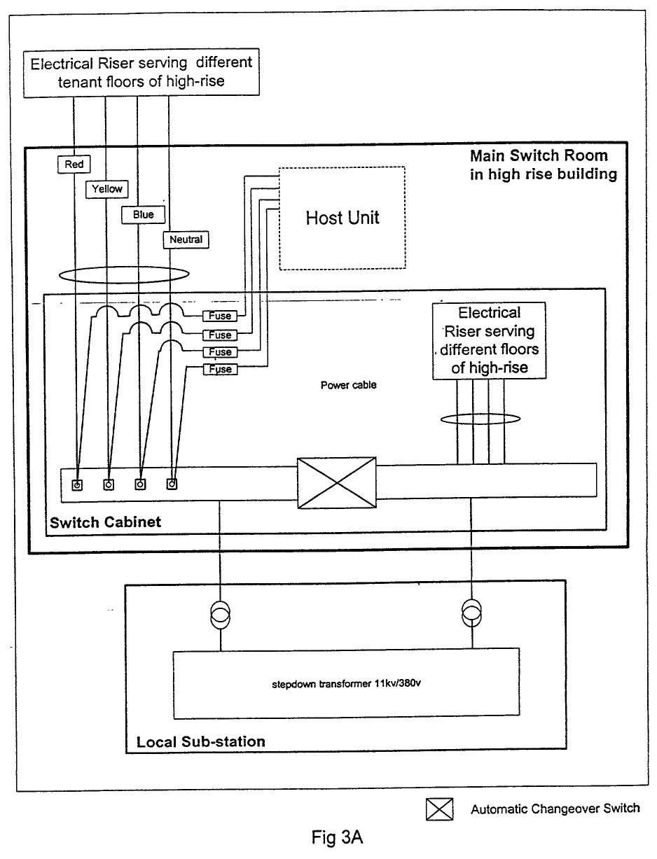

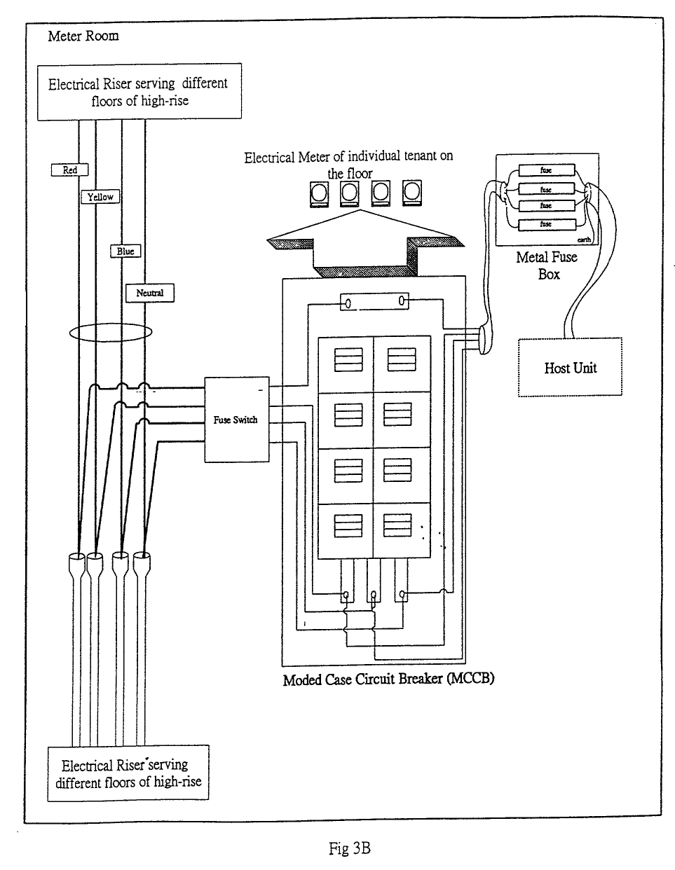

FIG. 3A shows a schematic representation of an exemplary embodiment of the host unit 160 coupled to the electrical network 130 according to the present invention. A main switch room 230 of, for example, a high-rise building 110 may include a portion of an electrical riser 240 and a switch cabinet 250. The electrical riser 240, which may include four power lines (e.g., three-phase power lines and a ground line), extends through the floors 140 and provides power to different floors 140. The electrical riser 240 may be, for example, a low voltage trunk rising from a bus bar 330 of the main switch room and may include panel boards that distribute electricity to different floors 140 of a multi-level building 110. The electrical riser 240 is coupled to the bus bar 330. The bus bar 330 is coupled to a local power substation 260 via a step-down transformer 270 as is known to those of ordinary skill in the art. Thus, the switch cabinet 250 receives power from an external power distribution grid via the local power substation 260.

The host unit 160 is connected to the different distribution facilities in the building 110 through, for example, one or more fuses. For example, the host unit 160 may be coupled to four fuses 280 which are, in turn, coupled to the electrical riser 240 via the bus bar 330. The fuses 280 provide an enabling interface between host units 160 and power distribution facilities in the building 110.

FIG. 3B shows a schematic representation of another exemplary embodiment of the host unit 160 being coupled to the electrical network 130 according to the present invention. In this example, the meter room 150 includes a portion of the electrical riser 240, a fuse box 290 with fuses 280, electrical meters 300, a circuit breaker panel 310 and a fuse switch 320. The host unit 160 is coupled to the four fuses 280 of the fuse box 290 (e.g., metal fuse box). The four fuses 280 of the fuse box 290 are coupled to bus bars 340 of the circuit breaker panel 310 (e.g., a moulded case circuit breaker). The bus bars 340 of the circuit breaker panel 310 are coupled to the fuse switch 320 which, in turn, is coupled to the portion of the electrical riser 240 in the meter room 150. Power from the electrical riser 240 reaches individual building units 120 via the fuse switch 320 and the circuit breaker panel 310 and the electrical meters 300. Power usage by individual building units 120 may be measured and displayed on the electrical meters 300 (e.g., watt-hour meters).

Although the host units 160 have been shown in exemplary embodiments to be installed in meter rooms 150 and switch rooms 230, the host units 160 can be installed anywhere to any device that distributes power to different building units 120 (e.g., residential units or commercial units) within the building 110.

Thus, it is seen that systems and methods for providing high-speed communications access are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the present invention as well.

What is claimed is:

1. A system for providing access to a communications network via an electrical network of a building, comprising:
a host unit disposed inside the building and having a first interface and a second interface, the first interface being coupled to the communications network via a connection device, the second interface being coupled to the electrical network of the building via a power distribution facility; and
a subscriber unit disposed inside the building and having a first interface that is coupled to the electrical network, the subscriber unit being in communications with the host unit via the electrical network of the building,
wherein the host unit receives communications signals from the communications network via the connection device, and
wherein the subscriber unit receives the communications signals from the host unit via the electrical network of the building.

2. The system according to claim 1, wherein the connection device is a router.

3. The system according to claim 2, wherein the router is a digital subscriber line (DSL) router.

4. The system according to claim 1, wherein the connection device is a switch.

5. The system according to claim 5, wherein the switch is an ethernet switch.

6. The system according to claim 1, wherein the connection device is a hub.

7. The system according to claim 6, wherein the hub is an ethernet hub.

8. The system according to claim 1, wherein the connection device is in communications with the communications network via a public telecommunications network equipment.

9. The system according to claim 8, wherein the modem is an asymmetric digital subscriber line (ADSL) modem.

10. The system according to claim 1, wherein the host unit is a plurality of host units, each host unit being directly connected to the connection device.

11. The system according to claim 1, wherein the first interface of the host unit is coupled to the connection device via a high-speed cable.

12. The system according to claim 1, wherein the first interface of the host unit is coupled to the connection device via at least one of a category 5 (CAT5) twisted pair cable, a CAT3 twisted pair cable, a single-mode optical fiber cable and a multimode optical fiber cable.

13. The system according to claim 1, wherein the connection device is in wireless communications with the communications network.

14. The system according to claim 1, wherein the connection device is coupled to the communications network via at least one of a category 5 (CAT5) twisted pair cable, a CAT3 twisted pair cable, a single-mode optical fiber cable and a multimode optical fiber cable.

15. A system for providing access to an internet via an electrical network of a particular building to subscriber units disposed in the particular building, comprising:
a router coupled to the internet;
a plurality of host units disposed on different floors of the particular building, each host unit having a first interface and a second interface, each first interface being coupled to the router via a respective network cable, each second interface being coupled to the electrical network of the particular building via a respective power distribution point of the particular building; and
a plurality of the subscriber units disposed inside the particular building and having a first interface that is coupled to the electrical network, the subscriber unit being in communications with the host unit via the electrical network of the particular building,
wherein the router receives data packets from the internet,
wherein one or more host units receive the data packets from the router, and
wherein the plurality of subscriber units receive the data packets from the one or more host units via the electrical network of the particular building.

16. A method for providing access to a communications network via an electrical network of a building, comprising the steps of:
(a) wiring a plurality of host units to power distribution points in the building;
(b) coupling the plurality of host units to a connection device;
(c) coupling the connection device to the communications network;
(d) coupling a plurality of subscriber units in communications with the plurality of the host units via the electrical network of the building; and
(e) distributing information from the communications network to subscriber units in the building via the plurality of host units.

17. The method according to claim 16, wherein step (b) includes the step of connecting the plurality of the host units to an ethernet hub.

18. The method according to claim 16, wherein step (b) includes the step of connecting the plurality of the host units to a digital subscriber line (DSL) router.

19. The method according to claim 16, wherein step (b) includes the step of connecting the plurality of the host units to an ethernet switch.

20. The method of claim 16, wherein step (b) includes the step of connecting the plurality of the host units to the connection device via category 5 (CAT5) twisted pair cables.

21. The method of claim 16, wherein step (b) includes the step of connecting the plurality of the host units to the connection device via fiber cables.

22. The method according to claim 16, wherein step (c) includes the step of connecting the connection device to a public telecommunications network equipment via a category 5 (CAT5) twisted pair cable or a CAT 3 twisted pair cable.

23. The method according to claim 22, further comprising the step of:
coupling the public telecommunications network equipment to the communications network via another CAT 3 twisted pair cable.

24. The method of claim 16, further comprising the step of:
(f) coupling a first subscriber unit of the plurality of the subscriber units in communications with a second subscriber unit of the plurality of the subscriber units via a particular host unit.
